(19) United States
(12) Patent Application Publication
(10) Pub. No.: US 2010/0159155 A1
(43) Pub. Date: Jun. 24, 2010

(54) Mining Component Coating Process

(76) Inventor: Mohan Kapahi, Mansfield, OH (US)

Correspondence Address: James Lindon, Lindon & Lindon, 35104 Saddle Creek, Avon, OH, 44011, US

(21) Appl. No.: 12/341,071

(22) Filed: Dec. 22, 2008

(51) Int. Cl. B05D 3/12; B06B 1/06; B06B 1/08

(52) U.S. Cl. 427/560

(57) ABSTRACT

A process for coating a mining component comprising processing the mining component within an ultrasonic frequency within the range of from about 25 KHz to about 40 KHz.

### BACKGROUND OF THE INVENTION

Components used for rock and ground stabilization in the mining industry must endure harsh conditions while maintaining strength and other performance standards. Failure of mining components can lead to catastrophic consequences. Current attempts to coat high performance mining components have been largely unsuccessful. There remains a long-felt need for a suitable means of making high-performance mining components.

### BRIEF DESCRIPTION OF THE DRAWINGS

FIG. 1 is a cross sectional view in elevation of a resin grouted rebar installation processed in accordance with an embodiment of the present invention.

FIG. 2 is a cross sectional view in elevation of a mechanical bolt installation processed in accordance with an embodiment of the present invention.

FIG. 3 is a cross sectional view in elevation of a frictional anchorage device processed in accordance with an embodiment of the present invention.

FIG. 4 is a cross sectional view in elevation of a cable bolt installation processed in accordance with an embodiment of the present invention.

FIG. 5 is a flow chart of a process in accordance with an embodiment of the present invention.

### SUMMARY OF INVENTION

There is provided a process for coating a mining component. The process may include processing the mining component in an alkaline solution and processing the mining component in an acidic solution and processing the mining component within an ultrasonic frequency within the range of from about 25 KHz to about 40 KHz and coating the mining component with a polymeric emulsion.

### DETAILED DESCRIPTION OF THE INVENTION

Preliminarily, it should be noted that certain terms used herein, such as for example above, below, upper, lower, left and right, are used to facilitate the description of the invention. Unless otherwise specified or made apparent by the context of the discussion, such terms and other directional terms should be interpreted with reference to the figure(s) under discussion. Such terms are not intended as a limitation on the position in which the invention or components may be used. Indeed, it is contemplated that the components of the invention may be easily positioned in any desired orientation for use. Likewise, numerical terms such as for example “first”, and “second” are not intended as a limitation or to imply a sequence, unless otherwise specified or made apparent by the context of the discussion. The term “operatively connected” is understood to include a linking together of the portions under consideration and may include a physical engagement and/or a functional or operational connection.

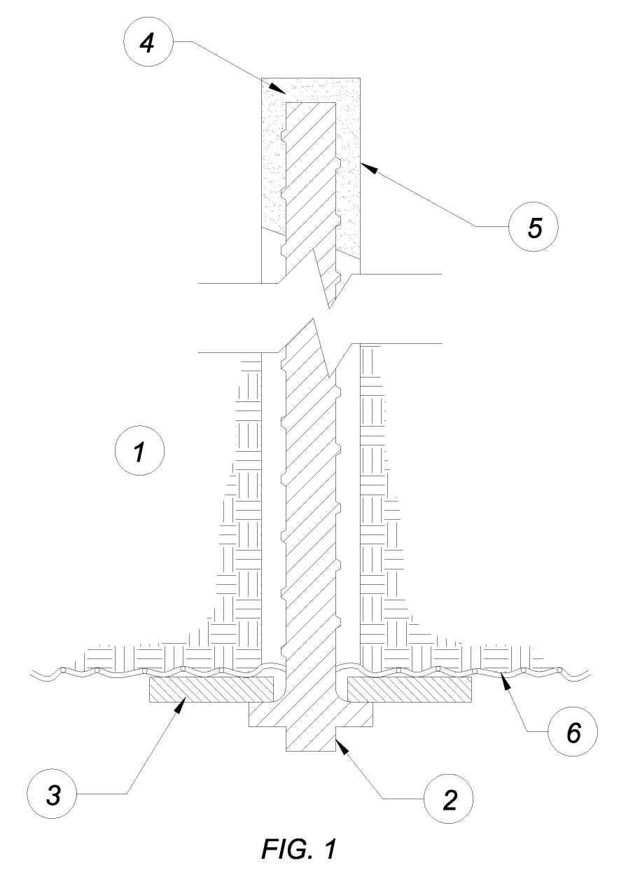

Referring now to the drawings, there are illustrated in FIGS. 1 through 5 a number of mining ground control components and assemblies and a process for coating mining components and assemblies according to the invention. The process for coating mining components is not limited to the particular mining components or installations shown herein—which are merely illustrative.

Referring now to FIG. 1, a number of mining components are shown. A drilled hole 5 is positioned in rock 1 as shown. A suitable epoxy resin 4 is shown in the drilled hole 5 around a headed deformed bar 2. A mine roof plate 3, which may also be referred to as a bearing plate, is shown generally positioned between the headed deformed bar 2 and a wire mesh 6. The portion of the headed deformed bar 2 which generally extends into the drilled hole 5 is shown positioned generally perpendicular to the mine roof plate 3. A grouted rebar installation is shown in FIG. 1.

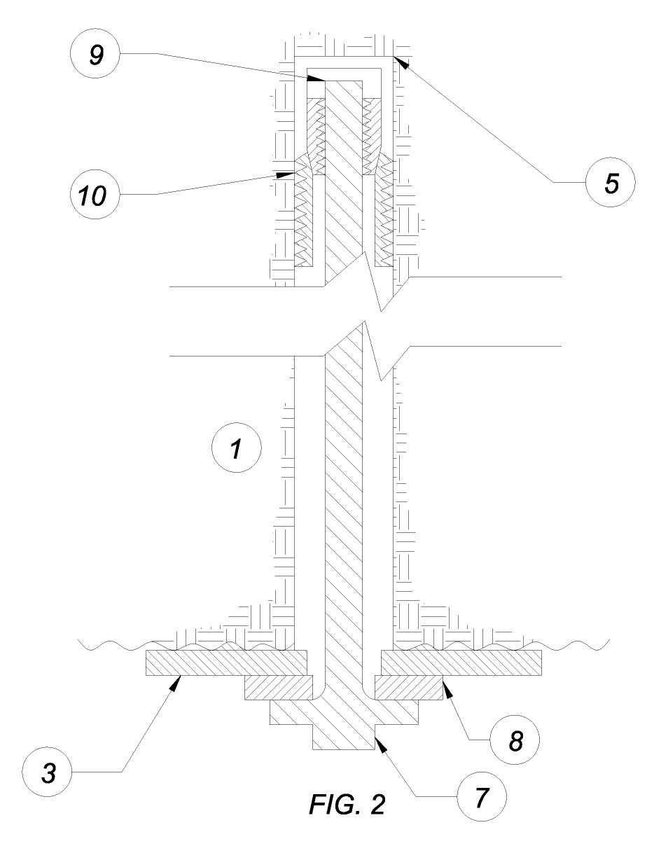

Referring now to FIG. 2, a number of mining components are shown. A drilled hole 5 is positioned in rock 1 as shown. A headed and threaded plain bar 7 is positioned in the drilled hole 5. Between the headed and threaded plain bar 7 and the rock 1 are a spherical washer 8 and a mine roof plate 3. An expansion shell 10 and threaded tapered plug 9 are positioned in the drilled hole 5 as shown. A mechanical bolt installation is shown in FIG. 2.

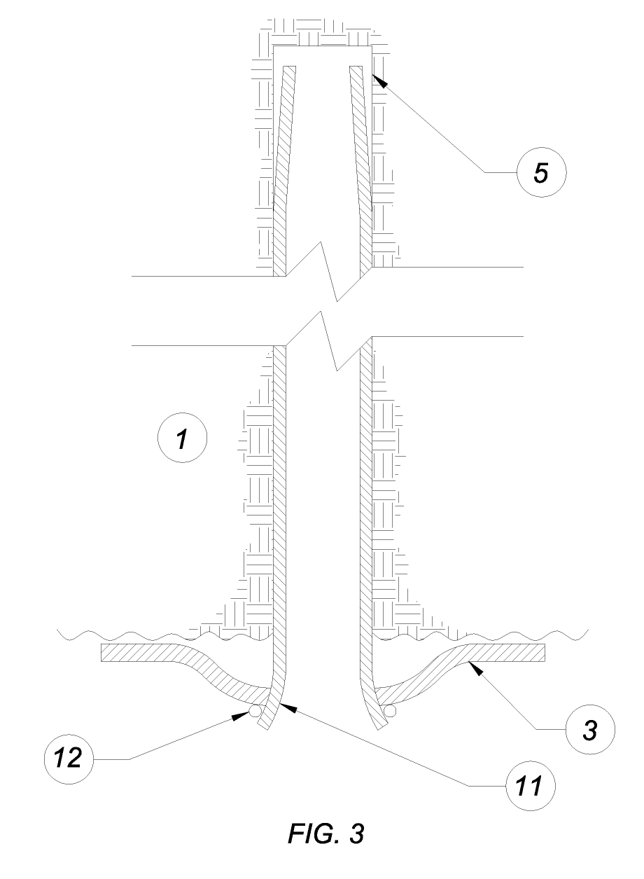

Referring now to FIG. 3, a number of mining components are shown. A drilled hole 5 is positioned in rock 1 as shown. A frictional anchorage device 11 is positioned in the drilled hole 5. The illustrated frictional anchorage device 11 is generally tapered at the lead end and, during installation, is press fit into the drilled hole 5. The mine roof plate 3 is positioned around the outer diameter of the frictional anchorage device 11. A welded wire ring 12 may be employed outside of the drilled hole 5 as shown. A frictional anchorage device installation is shown in FIG. 3.

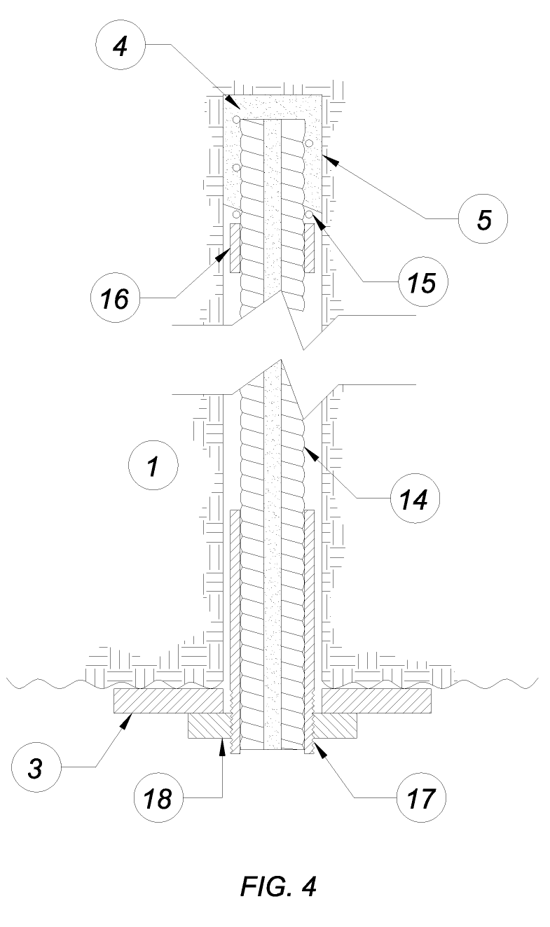

Referring now to FIG. 4, a number of mining components are shown. A drilled hole 5 is positioned in rock 1 as shown. A suitable epoxy resin 4 is shown in the drilled hole 5 around a plurality of steel wire mixers 15 and a steel wire cable 14. A swedged support 16 may be employed in the drilled hole 5 as shown. A threaded steel tube stiffener 17 may be employed around the circumference of the steel wire cable 14 and may generally extend from the drilled hole 5 as shown. A mine roof plate 3 and nut 18 may be positioned outside the drilled hole 5 as shown. A cable bolt installation is shown in FIG. 4.

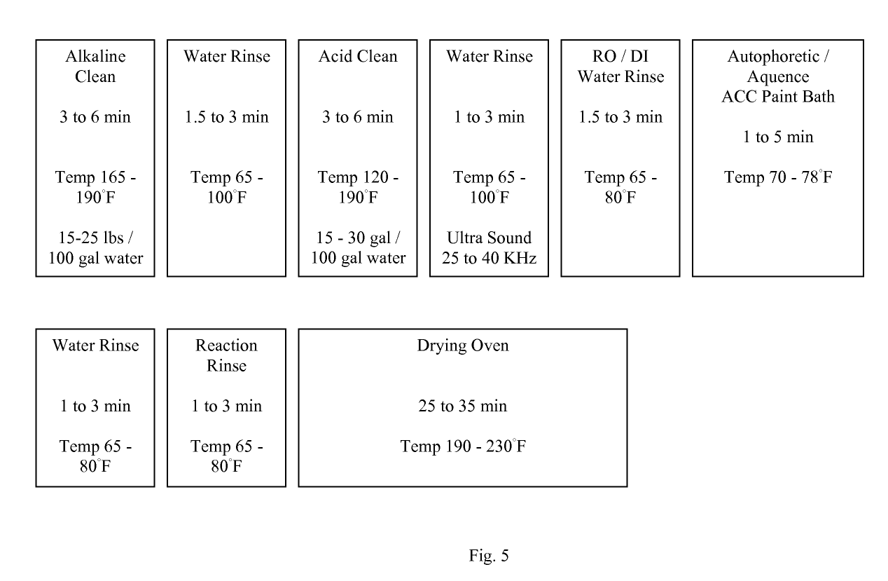

Referring now to FIG. 5, a process for coating mining components is shown. The illustrated process includes nine steps, though any suitable number of steps or ordering of steps may be employed—as may be the combining or further splitting of steps. The specific parameters of the steps and the specific steps shown and discussed are intended to be illustrative, and not limiting.

The first illustrated step may include an alkaline cleaning of the desired mining component. The alkaline cleaning may be conducted within the range of from about three minutes to about six minutes—or any other suitable amount of time. The alkaline cleaning may be applied within the range of from about 165 degrees Fahrenheit to about 190 degrees. An alkaline cleaning solution may be prepared with about one hundred gallons of water combined with about 15 to about 25 pounds of alkaline cleanser. The alkaline cleanser may include a suitable proportion of sodium phosphate (tribasic) within the range of from about thirty percent to about sixty percent of the total weight of the alkaline cleanser. The alkaline cleanser may include a suitable proportion of sodium hydroxide within the range of from about twenty percent to about thirty percent of the total weight of the alkaline cleanser. The alkaline cleanser may include a suitable proportion of a suitable surfactant or surfactants, which may be ethoxylated and within the range of from about one percent to about twenty percent of the total weight of the alkaline cleanser. An Autophoretic 1772 cleaner, available in commerce from Henkel Corporation may be employed.

An Autophoretic 2819 cleaner, available in commerce from Henkel Corporation may be employed for the alkaline cleaning. Along with the Autophoretic 2819 alkaline cleanser, an Autophoretic 7005 cleaner, available in commerce from Henkel Corporation may be employed for the acid cleaning as described herein. An alkaline cleaning solution may be prepared with about one hundred gallons of water combined with about one to about six gallons of alkaline cleanser. The alkaline cleaning may be applied within the range of from about 140 degrees Fahrenheit to about 180 degrees. The alkaline cleaning may be conducted within the range of from about one-half minute to about six minutes—or any other suitable amount of time. The alkaline cleanser may include a suitable proportion of potassium hydroxide within the range of from about ten percent to about thirty percent of the total weight of the alkaline cleanser. The alkaline cleanser may include a suitable proportion of potassium pyrophosphate within the range of from about one percent to about ten percent of the total weight of the alkaline cleanser. The alkaline cleanser may include a suitable proportion of a suitable surfactant or surfactants and within the range of from about one percent to about ten percent of the total weight of the alkaline cleanser.

The second illustrated step may include a water rinse. The water rinse may be applied within the range of from about 65 degrees Fahrenheit to about 100 degrees. The water rinse may be conducted within the range of from about one and one half minutes to about three minutes—or any other suitable amount of time.

The third illustrated step may include an acid cleaning of the desired mining component. The acid cleaning may be applied within the range of from about 120 degrees Fahrenheit to about 190 degrees. The acid cleaning may be conducted within the range of from about three minutes to about six minutes—or any other suitable amount of time. An acidic cleaning solution may be prepared with about one hundred gallons of water combined with about 15 gallons to about 30 gallons of acidic cleanser. The acidic cleanser may include a suitable proportion of phosphoric acid within the range of from about thirty percent to about sixty percent of the total volume of the acidic cleanser. The acidic cleanser may include a suitable proportion of sulfuric acid within the range of from about ten percent to about thirty percent of the total volume of the acidic cleanser. The acidic cleanser may include a suitable proportion of a suitable surfactant or surfactants within the range of from about one percent to about ten percent of the total volume of the acidic cleanser. An Autophoretic 7005 cleaner, available in commerce from Henkel Corporation may be employed.

The fourth illustrated step may include an ultrasonic water rinse of the desired mining component. An ultrasound source which supplies ultrasound within the range of from about 25 KHz to about 40 KHz may be employed, though any suitable source of ultrasound of any suitable standard may be used. The ultrasonic component of the process may be employed in a separate step or in conjunction with any other step of the process. The water rinse may be applied within the range of from about 65 degrees Fahrenheit to about 100 degrees. The water rinse may be conducted within the range of from about one minute to about three minutes—or any other suitable amount of time.

Processing the mining component with an ultrasonic frequency may include an ultrasonic transducer. An ultrasonic transducer is understood include a device that converts energy into ultrasound. The ultrasonic transducer may include a suitable piezoelectric crystal. Piezoelectricity is the ability of some materials to generate an electric potential in response to applied mechanical stress. This may take the form of a separation of electric charge across the crystal lattice. Piezoelectric crystals have the property of changing size when a voltage is applied, thus applying an alternating voltages across them causes them to oscillate at ultrasound frequencies. Transducers may be of a suitable piezoelectric material, such as lead zirconate titanate or barium titanate, or suitable magnetostrictive material, such as nickel or ferrite—or the like.

In an ultrasonic cleaning step, the mining component to be cleaned may be placed in a chamber containing a suitable ultrasound conducting fluid. Surfactants may be employed for this purpose. An ultrasound generating transducer may be built into the chamber, or lowered into the fluid. The ultrasound generating transducer produces ultrasonic waves, which creates compression waves in the liquid leaving behind microscopic bubbles resulting in cavitation. When these bubbles collapse, energy is released which aids in the cleaning process.

The fifth illustrated step may include a reverse osmosis water rinse and/or deionized water rinse of the desired mining component. The water rinse may be applied within the range of from about 65 degrees Fahrenheit to about 80 degrees. The water rinse may be conducted within the range of from about one minute to about three minutes—or any other suitable amount of time.

The sixth illustrated step may include an Autophoretic/Aquence bath of the desired mining component. The chemical coating is a process where a polymeric emulsion chemically deposits on the surface of a metal substrate—such as a mining component. The bath produces a generally uniform film over the entire surface of the mining component. The bath may be applied within the range of from about 70 degrees Fahrenheit to about 78 degrees. The coating process may be conducted within the range of from about one minute to about five minutes—or any other suitable amount of time.

The seventh illustrated step may include a water rinse of the desired mining component. The water rinse may be applied within the range of from about 65 degrees Fahrenheit to about 80 degrees. The water rinse may be conducted within the range of from about one minute to about three minutes—or any other suitable amount of time.

The eighth illustrated step may include a reaction rinse bath of the desired mining component. The reaction rinse may be applied within the range of from about 65 degrees Fahrenheit to about 80 degrees. The reaction rinse may be conducted within the range of from about one minute to about three minutes—or any other suitable amount of time. The reaction rinse bath may include ammonium bicarbonate within the range of from about five percent to about ten percent—or any other suitable percentage or amount. An Autophoretic 2150 reaction rinse, available in commerce from Henkel Corporation may be employed.

The ninth illustrated step may include a drying of the desired mining component. The mining component may be placed in a suitable drying oven within the range of from about 25 minutes to about 35 minutes—or any other suitable amount of time. The drying may be applied within the range of from about 190 degrees Fahrenheit to about 230 degrees.

The term “mining component” as used in this application may be understood to include, but is not limited to, any structure which could be used in a mine to support a rock structure or other structure in a mining environment or mining operation. Non-limiting examples of mining components include a roof plate, bearing plate, anchorage device, bolt, nut, cable, plug, washer, bar, shell, ring, support, wire mesh and the like. Basically, any component disclosed in this application and used in conjunction with the rock may be considered a mining component. Mining components may conform to ASTM F432-04 (Standard Specification for Roof and Rock Bolts and Accessories) or the like. The definitions herein are provided solely to facilitate an understanding of the invention—not to limit the invention.

Steps one through five are generally provided for cleaning of the mining component and to prepare the substrate to allow for the chemical auto-deposition process to occur more effectively.

In operation, one or more steps may be conducted in stainless steel tanks or other vessels of suitable anticorrosive material. Each solution may be prepared in volume increments of about one hundred gallons—or any other suitable volume. Appropriate pumps and piping may be employed for the solutions as desired. Where heating is conducted, heat exchangers or other suitable means of heating may be advantageous. Precleaning of the tanks or vessels may optimize performance of the operational step in question.

Experimental results demonstrated the utility of the claimed invention and yielded results that were greater than anticipated. Several experiments were conducted with processing of mining products to generate a sufficiently clean substrate for the autophoretic chemical reaction. For experiment 1, ACL 1772 (available in commerce from Henkel Corporation), a NaOH based alkaline cleaner with pH within the range of from about ten to thirteen, in a 20-30 percent concentrated solution was employed for a time period of about six minutes. The substrate was substantially rid of oils, soils and some mild rust. The observed mill scale and smuts were relatively unaffected. The Ultrasound was not used.

For experiment 2, ACL 2592 (available in commerce from Henkel Corporation), a NaOH based alkaline cleaner in a 20-25 percent concentrated solution was employed for a time period of about four minutes. The substrate was substantially rid of oils, soils and some mild rust. The observed mill scale and smuts were relatively unaffected. The process yielded a resulting adhesion failure of the coating within the range of from about ten to fifteen percent. Ultrasound was not used.

For experiment 3, ACL 2592 (available in commerce from Henkel Corporation), a KOH based alkaline cleaner in a five to seven per cent concentrated solution was employed for a time period of about two to six minutes. The observed mill scale and smuts were relatively unaffected. The process yielded a resulting adhesion failure of the coating within the range of from about two to five percent. Ultrasound was not used.

For experiment 4, ACL 7320 (available in commerce from Henkel Corporation), an acidic soak was employed for a time period of about one to two minutes. Ultra sound was used for about one to two minutes in conjunction as described herein. The process yielded a resulting adhesion failure of the coating within the range of from about one percent.

For experiment 6, ACL 7005 (available in commerce from Henkel Corporation), a phosphoric acid soak was employed for a time period of about ten minutes. Ultra sound was used in conjunction for about one minute as described herein. The process yielded a resulting adhesion failure of the coating within the range of from about one to five percent.

For experiment 5, alkaline 2819 (available in commerce from Henkel Corporation), a KOH based alkaline soak was employed for a time period of about two minutes. ACL 7005 (available in commerce from Henkel Corporation), a phosphoric acid soak was employed for a time period of about five minutes. Ultra sound was used for about one to two minutes in conjunction as described herein. The process yielded a resulting adhesion failure of the coating of less than about one percent.

The invention may be made from any suitable material and by any suitable method. The invention may be adapted to fit a wide variety of uses. It will be appreciated that the components of the invention may be easily modified as needed to accommodate varying sizes and shapes.

It is to be understood that the invention is not limited in its application to the details of construction and to the arrangements of the components set forth in the accompanying description or illustrated in the drawings. The invention is capable of other embodiments and of being practiced and carried out in various ways. Also, it is to be understood that the phraseology and terminology employed herein are for the purpose of description and should not be regarded as limiting. The disclosure may readily be utilized as a basis for the designing of other structures, methods and systems for carrying out the present invention. It is important, therefore, that the claims be regarded as including equivalent constructions. Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract and disclosure are neither intended to define the invention of the application, which is measured by the claims, nor are they intended to be limiting as to the scope of the invention in any way.

What is claimed is:

1. A process for coating a mining component comprising:
processing the mining component in an alkaline solution;
processing the mining component in an acidic solution;
processing the mining component within an ultrasonic frequency within the range of from about 25 KHz to about 40 KHz; and
coating the mining component with a polymeric emulsion.

2. The process of claim 1 wherein the alkaline solution contains sodium phosphate.

3. The process of claim 2 wherein the alkaline solution contains sodium hydroxide.

4. The process of claim 1 wherein the acidic solution contains phosphoric acid.

5. The process of claim 4 wherein the acidic solution contains sulfuric acid.

6. The process of claim 1 wherein the step of processing the mining component with an ultrasonic frequency of from about 25 KHz to about 40 KHz includes an ultrasonic transducer having a piezoelectric crystal.

7. The process of claim 1 wherein the step of processing the mining component with an ultrasonic frequency of from about 25 KHz to about 40 KHz includes an ultrasonic transducer made from a magnetostrictive material.

8. The process of claim 7 wherein the magnetostrictive material is nickel.

9. The process of claim 1 wherein the step of processing the mining component with an ultrasonic frequency of from about 25 KHz to about 40 KHz includes an ultrasonic transducer made from lead zirconate titanate.

10. The process of claim 1 wherein the step of processing the mining component with an ultrasonic frequency of from about 25 KHz to about 40 KHz includes an ultrasonic transducer made from barium titanate.

11. A process for coating a mining component comprising:
processing the mining component in an acidic solution;
processing the mining component with an ultrasonic frequency within the range of from about 25 KHz to about 40 KHz; and
coating the mining component with a polymeric emulsion.

12. The process of claim 11 wherein the step of processing the mining component with an ultrasonic frequency of from about 25 KHz to about 40 KHz includes an ultrasonic transducer having a piezoelectric crystal.

13. The process of claim 11 wherein the step of processing the mining component with an ultrasonic frequency of from about 25 KHz to about 40 KHz includes an ultrasonic transducer made from a magnetostrictive material.

14. The process of claim 13 wherein the magnetostrictive material is nickel.

15. A process for coating a mining component comprising:
processing the mining component in an alkaline solution;
processing the mining component with an ultrasonic frequency within the range of from about 25 KHz to about 40 KHz; and
coating the mining component with a polymeric emulsion.

16. The process of claim 15 wherein the step of processing the mining component with an ultrasonic frequency of from about 25 KHz to about 40 KHz includes an ultrasonic transducer having a piezoelectric crystal.

17. The process of claim 15 wherein the step of processing the mining component with an ultrasonic frequency of from about 25 KHz to about 40 KHz includes an ultrasonic transducer made from a magnetostrictive material.

18. The process of claim 17 wherein the magnetostrictive material is nickel.

19. The process of claim 15 wherein the step of processing the mining component with an ultrasonic frequency of from about 25 KHz to about 40 KHz includes an ultrasonic transducer made from lead zirconate titanate.

20. The process of claim 15 wherein the step of processing the mining component with an ultrasonic frequency of from about 25 KHz to about 40 KHz includes an ultrasonic transducer made from barium titanate.
